(19) United States
(12) Patent Application Publication
(10) Pub. No.: US 2024/0217569 A1
(43) Pub. Date: Jul. 4, 2024

(54) Horticulture Mobile Workstation

(71) Applicants: Claude A. Burnett, III, Edmond, OK (US); Logan A. Burnett, Jones, OK (US)

(72) Inventors: Claude A. Burnett, III, Edmond, OK (US); Logan A. Burnett, Jones, OK (US)

(21) Appl. No.: 18/092,729

(22) Filed: Jan. 3, 2023

(51) Int. Cl. B62B 1/12; B62B 1/00

(52) U.S. Cl. CPC B62B 1/12; B62B 1/004

(57) ABSTRACT

A cart within a cart design for use in horticulture activities. The device has multiple uses and accessories for various purposes when handling and tending to plants. It is designed to take up minimal space and mitigate physical strain for the user.

### CROSS REFERENCE TO PRIOR FILED APPLICATION

This application claims priority to U.S. Provisional Application No. 63/295,633 filed on Dec. 31, 2021

### BACKGROUND

### Field of Use

The subject matter in this patent application is a horticulture mobile workstation optimized in shape and size for greenhouses and indoor horticulture facilities.

The preferred embodiment of the device consolidates the materials needed for indoor or small-scale horticulture harvesting into a device with a small footprint. This improves the productivity of harvesting operations and minimizes the space consumption during a harvesting operation.

The preferred embodiment of the device allows for a cart within a cart design. The larger outer cart is designed to remain in the aisle during the harvest process. The smaller inner dolly is designed to hold a standard multi-gallon container for holding potting soil and plant parts along with miscellaneous potting containers. The smaller inner dolly has multiple features and can be separated from the larger outer cart.

The preferred embodiment of the device minimizes the wastes associated with harvesting, minimizes the time it takes to dispose of said wastes, and improves productivity.

The preferred embodiment of the device mitigates safety issues involved in harvesting.

The preferred embodiment of the device provides an ergonomic placement for waste containers.

The preferred embodiment of the device provides a mobile workstation for many horticulture activities.

The preferred embodiment of the device mitigates the space taken up within the aisles by the cart.

The device consists of an outer cart and an inner dolly which fits longitudinally within the outer cart.

The subject matter of this patent application is meant to apply to indoor cannabis horticulture operations and other types of greenhouse environments, indoor and other types of horticulture and harvesting operations.

### Background of the Prior Art

The problem solved with this invention is that harvesting of plants within a greenhouse or indoor horticulture facility involves multiple ancillary materials in addition to the product/plant handling. Additionally, these facilities are typically space constrained due to the financial desire to maximize floor space for plant growth.

Horticulture carts currently on the market are a single or dual level platform style carts, simple wagons, or a two wheeled dolly type device. These devices are not ideal for the small aisle spaces and confines of the indoor horticulture operations. These devices make it difficult for users to move around within the tight or confined spaces they are trying to work. These devices are not ergonomically designed to mitigate injury to the user and maximize freedom of movement. Approximately a flexible intermediate bulk container (FIBC) tote, bucket, or other type of container for holding waste, which can be heavy for the user and potentially unsafe to carry, is used in most facilities and typically is hand carried. These containers can be heavy and cumbersome for users and moving them in a small, confined space can cause injury or other accidents.

No single device is present in the market to address horticultural operations in an organized, motion constrained manner where whole plants are harvested, transported, and all ancillary materials are removed from the horticulture site and either transported for disposal or to a cleaning station for re-use.

Current horticulture technology primarily focuses on flat planar surfaces (some on multiple planes) for large horticultural carts operating in areas without the space constraints of green houses or indoor horticulture facilities. Our invention maximizes use of spatial constraints by controlling the use of unique volumetric space within the device. Some technologies currently marketed, incorporate an elevated shelf supported by adjustable vertical supports. However, none appear to offer the flexibility for positioning the shelf in multiple positions along the horizontal plane. Our invention gives numerous configuration options to apply to specific users' needs. No one has attempted to consolidate plant/product collection, ancillary materials, hanger collection, and planter pot collection into a single rolling workstation for the sole purpose of supporting the unique requirements of green houses and indoor horticulture facilities. Our horticultural mobile workstation has combined all the above horticultural related materials within a mobile, multifunctional, and within a tightly constrained spatial three dimensional envelope.

No available technology exists that has focused on the unique ergonomics or lean horticulture techniques to minimize wasted motion of the operator/worker while harvesting or performing any other horticulture activities that could interact with the “horticultural mobile workstation”.

The current issue with the existing technology is there isn't a maximum use of the space available that takes up a minimal amount of space. Nothing is currently known nor exists on the market to prevent such problems.

### DESCRIPTION

Disclosed herein is a horticulture mobile workstation featuring a cart within a cart design.

This invention consolidates all ancillary materials and product/plant collection in the smallest volumetric configuration possible which 1) improves the productivity of harvesting operations and 2) reduces ergonomics and safety issues; and 3) minimizes the space consumption during the harvesting operation. Productivity is improved by minimizing the excess motion associated with these operations (i.e., physically managing multiple containers randomly positioned and individually moved as the horticulture operation proceeds linearly down the plant line).

The invention utilizes standard 5-gallon buckets (or other alternative container) in a narrow, vertically stacked configuration, which significantly speeds-up the processing of ancillary materials resulting in the harvesting process.

This invention, the “mini-horticultural mobile workstation,” involves a “cart within a cart” design. The larger, outer cart (hereinafter also referred to as the “Harvest Cart”) has a bidirectional (longitudinal) removal/insertion design to remain in the aisle during the harvesting process (i.e., separating the product/plant from the potted soil and ancillary materials). The inner, smaller cart (hereinafter also referred to as the “Shuttle Dolly”) is designed to fit longitudinally within the harvest cart. The shuttle dolly holds a Flexible Intermediate Bulk Container (FIBC) tote (or other alternative container or used with no container) for holding potting soil and root ball (i.e. biomass) along with the associated potting plant containers. This Shuttle Dolly is used to transport the tote, subsequent waste, and empty potting plant containers from the harvest area for disposal or further processing. The bi-directional design allows the inner cart to be operated and removed from the horticulture room from either end of the cart which enables the horticulture facility to have workers to operate simultaneously with the workstation from either end. The Shuttle Dolly has locating features (2 or more) to accommodate the hanging/handle loops of the FIBC totes (if used) to keep the tote open for presentation to the worker. Additionally, the Shuttle Dolly has a containment feature to control the deformation of the FIBC tote (or alternative) as it is filled with biomass.

The Shuttle Dolly (1) is designed to offer vertical supports in two positions at each end allowing for the hanging bar or product/plant hanger/s (3) or other apparatus to be used above the FIBC tote or container. This adjustable vertical support with cantilevered “hanging” bar (3) extends laterally above the FIBC tote or container. The height of the hanging bar (3) is adjustable to accommodate maximum plant lengths, which enables the unobstructed placement of harvested plants above the FIBC tote.

The overall Harvest Station dimensions are optimized for narrowest aisles associated with an indoor horticulture facility. The dimensions of this “mini Horticultural mobile workstation” are 14-16 inches wide, 31 inches tall (excluding container racks) and 26 inches long (dimensions may vary) which is small enough to fit into some of the narrowest indoor aisles. The height may or may not be adjustable within the Harvest cart frame.

The worker loads the Harvest Station while standing in the aisle. The vertical shape and configuration are uniquely designed to reduce contact/damage with/to product/plants which may protrude into the aisleway. The upper frame and container racks (4) of the Harvest Cart is designed so 1) the width (laterally) is narrower than the lower frame, 2) overall width is minimal and governed by the container size only and not the supporting frame (i.e. frame is directly below the containers), and 3) is swappable with other “upper frame configurations”. The upper frame/rack configurations (accessories) may be in numerous forms and configurations to support smaller or larger containers, tool racks, light systems, than the 5-gallon buckets. The lateral and longitudinal dimensions of the Harvest Cart's lower frame are designed in what could be termed a “X” (6) shape to meet all required design requirements while also enabling tight maneuvers and easy disposal of root ball/biomass into the FIBC tote (or alternative container) within an indoor horticulture facility. The “X” shape also enables workers to personally maneuver around the Harvest Station while positioned in the aisle. Additionally, the Shuttle Dolly has various planting pot fixtures (i.e., to accommodate various configurations of planting pots) which are attached to the base of the dolly.

The Harvest Cart also referred to as the Outer cart is designed to offer a vertical support in selectable X, Y and Z positions allowing for the product/plant hanger/s or other apparatus to be used above the 5-gallon buckets (or another container). This adjustable vertical support with cantilevered “hanging” bar extends laterally above the 5-gallon buckets. The height of the hanging bar is uniquely determined to accommodate maximum plant lengths, which enables the unobstructed placement of harvested plants above the 5-gallon buckets.

The Shuttle Dolly incorporates a removeable/transferable handle (13) with adjustable heights for maneuvering the dolly or the workstation when in the “nested” mode. The Inner dolly possesses locating features for controlling the position and stability of the FIBC tote (or alternative) during transport. The Shuttle Dolly also embodies a holding fixture (9) for planter pots/containers at each end of the device. The connection mechanism replicates the removable handle or may be attached to the handle. The Shuttle Dolly has locating or positioning features (15) (i.e., magnetic, physical, or hand-operated latching mechanisms) for controlling the alignment of the Shuttle Dolly when in the ‘nested mode’ to prevent unintentional separation as the ‘cart within a cart’ system is moved or stationary in ‘nested’ mode. Both the Shuttle Dolly and Harvest cart may or may not share common base dimensions, with various fixed or swiveling casters of consistent or various wheel diameters or other rolling implements to enable maneuverability when in ‘nested mode.’ The Shuttle Dolly embodies a universal or custom ‘hanger storage rack’ (16) accessory which may be positioned on either side or end of the device. The hanger storage rack (16) allows for the storage of multiple unused hangers to minimize down time of the harvester. The harvest or outer cart also includes at least one or more magnetic tool holder(s) (18) positioned for ease of access.

The outer cart and/or inner dolly has/have locating or positioning features (i.e., magnetic or hand operated latching mechanism) for controlling the alignment of the Inner dolly when in the “nested mode” to prevent unintentional separation as the “cart within a cart” system (i.e., Horticultural mobile workstation) is moved in unison.

Both the inner dolly and outer cart may/or may not share common base dimensions, with various fixed or swiveling casters to enable maneuverability when in the “nested mode”. The outer cart embodies a universal or custom “hanger storage rack” accessory, which may be positioned on either side or end of the cart. This hanger storage rack allows for the storage of multiple unused hangers to minimize down time of the harvester.

The device is superior to existing technologies by consolidating the plants harvested and the materials needed to harvest and tend the plants into a device that occupies minimal space. This device is considerably narrower and shorter than other devices on the market, taking up considerably less space and increasing functionality in an indoor horticulture facility.

An example of the device measurements of an embodiment of the device are 14-16 inches wide by a 31 inch height by a 26 inch length. There is a vertical rack to hang and position harvesting products or plants within the same footprint of the cart.

Essential elements of the invention include the cart within a cart design and storage elements; the system of optimized worker use of the device while carrying out a whole or partial plant harvest; movement of the device along a longitudinal plane; spatial configuration to match the space constraints within the aisles and harvest areas; the outer cart portion remaining in the aisle as harvesting proceeds and while other materials and matter are removed from the area; the inner cart portion that can be positioned under the outer cart to conserve floor space and eliminate the wasteful transfer of plant materials, such as root balls, and planter pots; the inner cart can also secure and transport the large storage or tote like container along with other pots; vertical support rack with multiple positioning options for a bucket or other vessel; multiple positions along the surface of the cart for placement of said vertical support rack; product or plant hanger bar with multiple vertical positions; a movable horizontal hanger storage racks and at least one stationary shelves for storage hangers; securing feature for large storage vessel or tote; and securing features or latch type mechanism to secure inner cart and outer cart together.

Optional elements of the device include but are not limited to: folding capabilities of horticultural mobile workstation to minimize space consumption when not in use; an alternative configuration that enables movement of horticultural mobile workstation along the transverse axis, which would not encumber the usage of aisles; custom-fit hanger storage rack accessory; planter pot fixtures of adjustable or various configurations to accommodate different planter pots; optional fourth container hanging from end of outer Cart nearest the inner cart entrance; or on the multi-gallon container; optional laptop mount/shelf container hanging from end of Outer cart nearest the Inner dolly entrance; FIBC tote fixtures of adjustable or various configurations to accommodate different size totes; outdoor version of this invention with larger dimensions, larger wheels or other rolling implements, etc.; and light (battery powered) attached to the Vertical Hanging rack which can be triggered by the harvesting operator to notify support personnel for assistance; a feature which may be a physical indicator or an electronic sensor (battery powered) which signals the operators that the wastes contained in the Inner dolly have reached their maximum sustainable level; adjustable overall height, length, and width of the 5-gallon bucket (or alternative) support (i.e. upper frame) structure; adjustable overall height, length, and width of the base frame (i.e., lower frame) to accommodate various configurations of FIBC totes (or other containers); modular hanger rack (i.e., single rack in use) to attach to the vertical posts and accommodate multiple brands of hangers. (Foldable option also); additional vertical posts used for any purpose located on the upper frame of the Outer cart (e.g., one positioned near the Inner dolly handle to provide easier access to for the operator in the aisle); and/or battery powered weighing station which can be optionally attached to the Outer cart and be utilized by the workers/operators interfacing with the “horticultural mobile workstation”.

The preferred embodiment of the device is made by cutting and welding of Al (aluminum) or SS (stainless steel) tubing and Al or SS sheet, or Assembly of T-slotted Al bars; cutting of Al or SS materials to the configurations required; drilling of necessary holes; assembly of fixed and swiveling casters to sheet metal via appropriate fasteners; and insertion thumbscrew on vertical support.

The preferred embodiment of the Invention's structure consists of Aluminum or Stainless-steel tubing and sheet metal, which is cut to predetermined dimensions and welded or bolted together. Overall dimensions are approximately 26 inches long, 14-16 inches wide and 31 inches high. The proportions or dimensions of this invention can be changed to accommodate various horticultural requirements. The preferred embodiment of the invention consists of two rolling/mobile devices with nesting capabilities.

The outer cart is the larger of the two devices and has an opening at only one end for the insertion of the inner dolly. The Inner dolly is the smaller of the two devices and has a single platform with two sets of positioning or accessory fixtures (i.e., for FIBC tote and planter pots or alternative containers). Base frame of the Outer cart is configured so the interior dimensions are large enough to accommodate the height and width of a FIBC tote while simultaneously minimizing the overall width of the Outer cart. Again, these interior frame dimensions can be changed to accommodate various horticultural requirements. The base frame has one sheet metal plate (i.e., end plate) welded to the tubing frame at one end (opposite the Inner dolly entrance). The upper frame of the Outer cart is configured to be narrower than the base frame to accommodate plant intrusion into aisle ways yet allow for the commonly used 5-gallon buckets or other containers to be stored/supported. The upper frame spanning the entire length is completely free from support other than the two furthest ends of the base frame, which allows full access to the FIBC tote (or alternative) and the planter pot fixtures. The upper frame is configured for the vertical plant/product hanger support in 4-8 locations and ensures solid retention/rigidity of the vertical hanger support with vertical adjustability. The vertical hanger support (used to place one hanger) has a fixed retention feature (e.g., shaft collar) which allows lowering the vertical hanger support to the lowest position without interfering with the extraction of the Inner dolly with a FIBC tote (or alternative) but simultaneously allows the nested carts or Outer cart to be rolled through a standard height doorway. The upper frame supports the two mobile “hanger support racks”, which may hold multiple hangers for easy access by the harvesting operator. Outer cart possesses an optional folding feature which enables it to collapse and reduce its volumetric consumption.

Alternative options for the device include but are not limited to: bolted assembly of solid metal bars instead of lightweight tubing; use of non-metallics for frame materials; instead of the cart within a cart design, it could be made as a single unit which limits its functionality somewhat; in addition to the two main devices (i.e., outer cart and inner dolly) within this invention, there could be multiple devices for unique functions that nest for the purpose of horticultural operations; and/or in addition to one vertical post, there could be a multiple, independent vertical posts used for any purpose.

All elements of the device can be modified to encompass additional interchangeable elements that would be relevant to horticulture activities and tasks.

The preferred embodiment of the device comprises: a cart within a cart and additional use and storage elements.

As used herein, the term “cart” is meant to encompass a small vehicle pushed or pulled by hand.

As used herein, the term “dolly” is meant to encompass a low vessel or cart with wheels or other rolling implements for moving loads or items too heavy to be safely carried by hand.

It is an object of the present invention to minimize the wastes associated with normal harvesting thus improving productivity. These wastes primarily involve excess movement of the workers and operators.

It is an object of the present invention to minimize the safety hazards involved in harvesting such as lifting, squatting, and/or bending over.

It is an object of the present invention to improve the ergonomic placement of waste containers.

It is an object of the present invention to provide a mobile workstation for horticulture activities.

It is an object of the present invention to provide a mobile workstation for Horticulture activities beyond harvesting.

It is an object of the present invention to minimize aisle space consumption by offering a cart within another cart design.

Although the invention has been described in detail with reference to several embodiments additional variations and modifications exist within the scope of the spirit of the invention as described.

Although the disclosed invention has been described with reference to various exemplary embodiments, it is to be understood that these embodiments are merely illustrative of the principals and application of the present invention. Those having skill in the art would recognize that various modifications to the exemplary embodiments may be made, without departing from the scope of the invention.

Moreover, it should be understood that various features and/or characteristics of differing embodiments herein may be combined with one another. It is therefore to be understood that numerous modifications may be made to the illustrative embodiments and that other arrangements may be devised without departing from the scope of the invention.

Furthermore, other embodiments of the invention will be apparent to those skilled in the art from considerations of the specification and practice of the invention disclosed herein. It is intended that the specification and examples be considered as exemplary only, with a scope and spirit being indicated by the claims.

Finally, it is noted that, as used in this specification and the appended claims, the singular forms “a”, “an”, and “the,” include plural referents unless expressly and unequivocally limited to one referent, and vice versa. As used herein, the term “includes” or “comprising” and its grammatical variants are intended to be non-limiting, such that recitation of an item or items is not to the exclusion of other like items that can be substituted or added to the recited item(s).

### DESCRIPTION OF THE DRAWINGS

### Drawing Components:

1. Outer cart
2. Inner dolly
3. Hanging bar
4. Upper frame and support racks
5. Longitudinal frame member
6. Base of outer cart
7. Open end of base of outer cart
8. Open space of outer cart frame
9. Accessory fixture for 1-2 sets of planter pots or containers
10. First barrier
11. Second barrier
12. Third barrier
13. Inner dolly handle
14. T-shape as a portion of the base of the inner dolly.
15. Accessory location
16. A shelf portion
17. Attachment portion featuring a magnetic or other securing mechanism.
18. Magnetic tool holder
19. Flexible intermediate bulk container (FIBC)
20. Mounting sleeve for hanging bar
21. Rolling implement or wheels

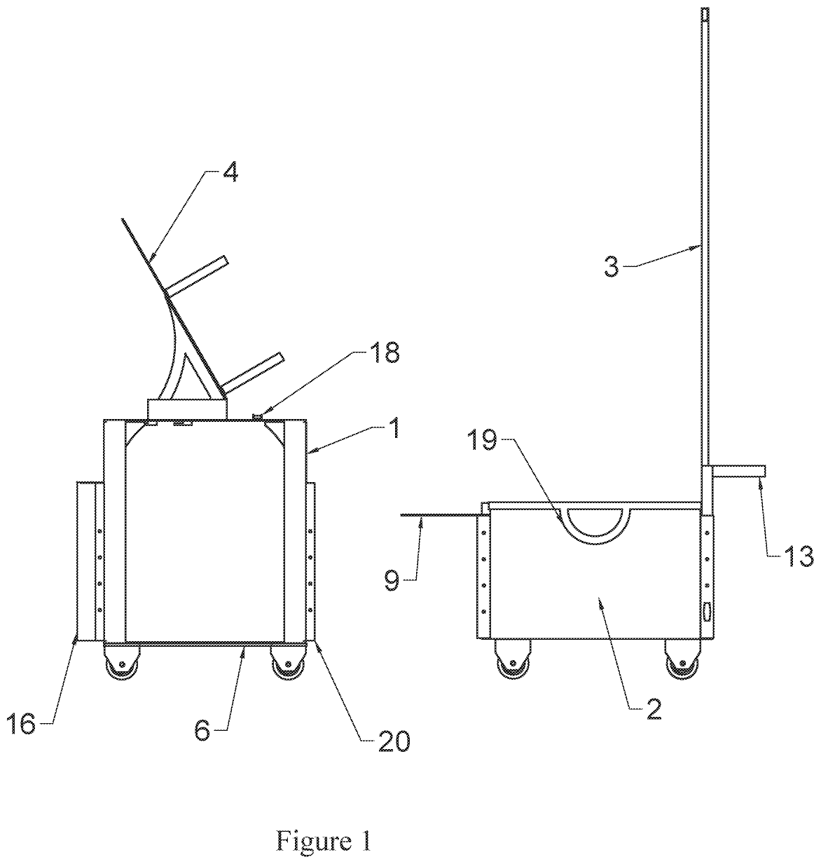

FIG. 1 is a separated side view of the preferred embodiment of the device.

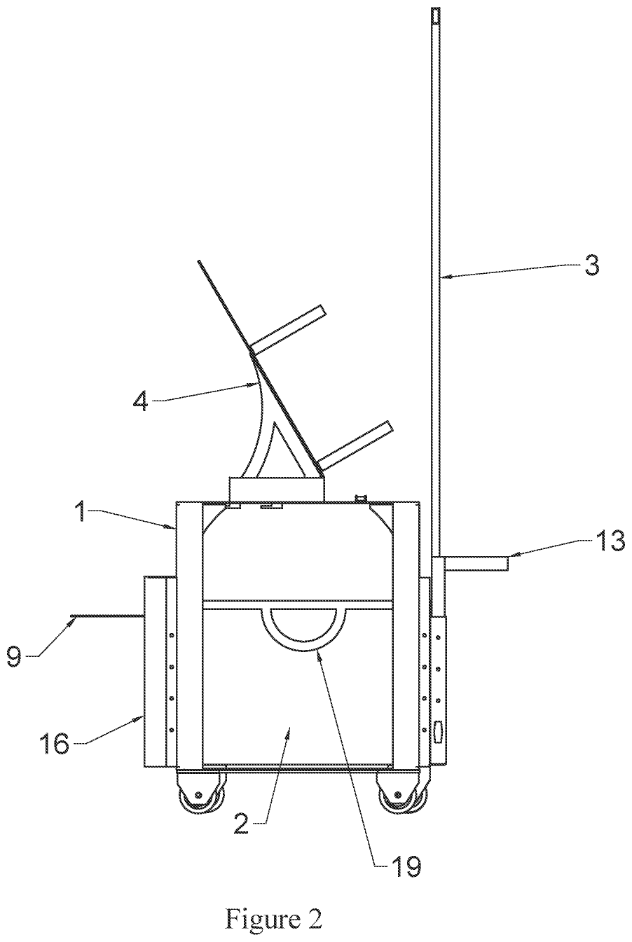

FIG. 2 is a side view of the preferred embodiment of the device.

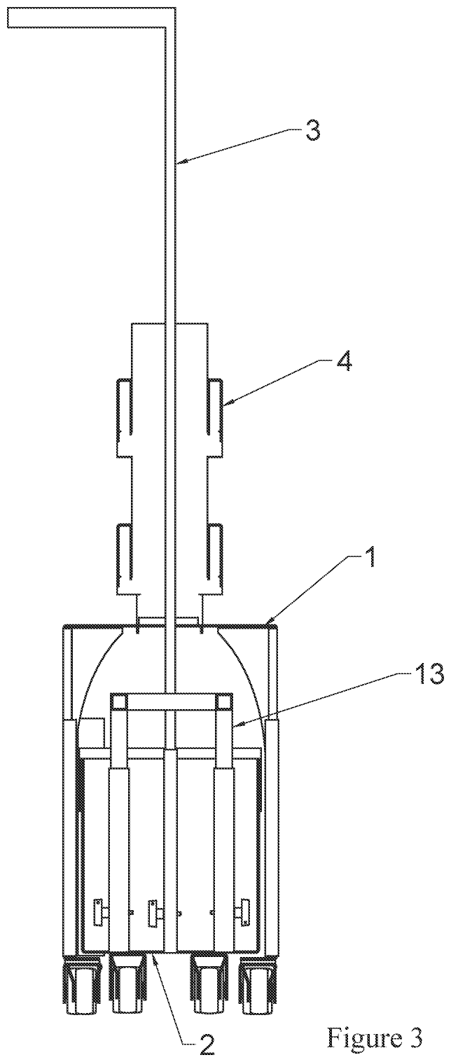

FIG. 3 is a frontal view of the preferred embodiment of the device.

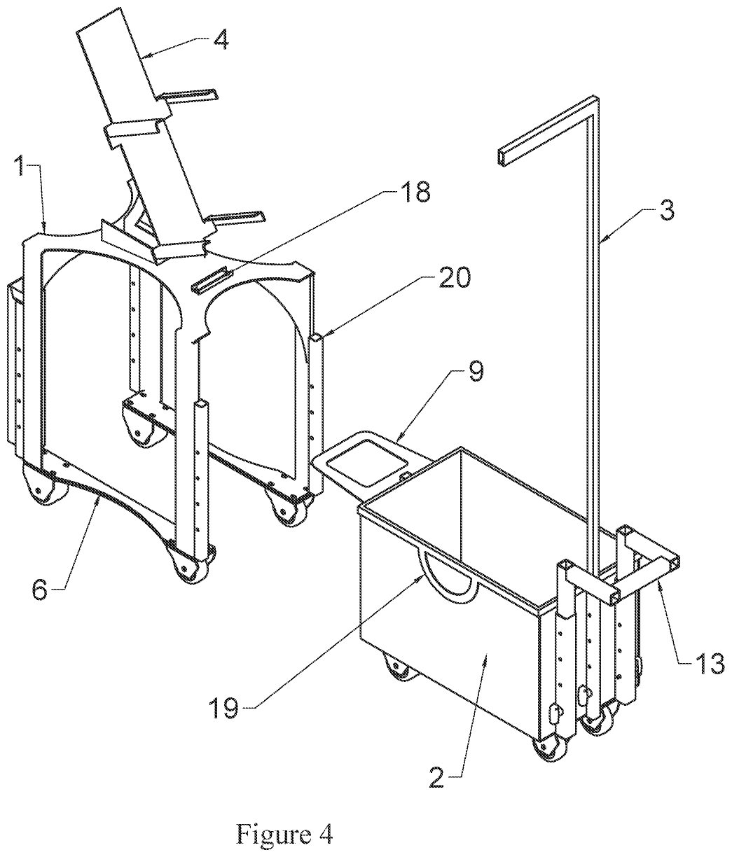

FIG. 4 is a perspective view of the preferred embodiment of the device.

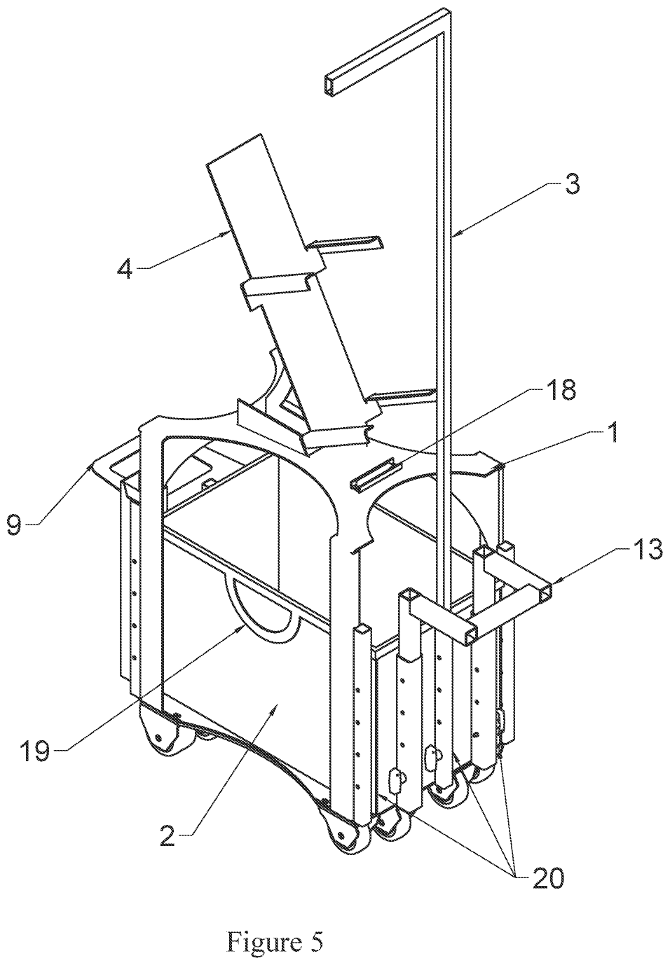

FIG. 5 is a perspective view of the preferred embodiment of the device.

### DETAILED DESCRIPTION OF THE DRAWINGS

FIG. 1 is a separated side view of the preferred embodiment of the device featuring the outer cart (1) with upper frame (4), magnetic tool holder (18), shelf portion (16), base (6), and mounting sleeve for hanging bar (20); inner cart (2) with hanging bar (3), inner dolly handle (13), accessory fixture (9), and flexible intermediate bulk container (19).

FIG. 2 is a side view of the preferred embodiment of the device featuring the outer car (1) and inner dolly (2) joined together with additional elements hanging bar (3), inner dolly handle (13), flexible intermediate bulk container (19), shelf portion (16), accessory fixture (9), and upper frame (4).

FIG. 3 is a frontal view of the preferred embodiment of the device featuring the inner dolly (2) inside of the outer cart (1), inner dolly handle (13), hanging bar (3) and the upper frame (4) of the outer cart.

FIG. 4 is a perspective view of the preferred embodiment of the device featuring the outer cart (1) with upper frame (4), magnetic tool holder (18), mounting sleeve for hanging bar (20); and inner dolly (2) with FIBC tote (19), accessory fixture (9), hanging bar (3), and inner dolly handle (13).

FIG. 5 is a perspective view of the preferred embodiment of the device featuring the inner dolly (2) inside of the outer cart (3) further showing the mounting sleeves (20) for the hanging bar (3), inner dolly handle (13), magnetic tool holder (18), upper frame (4), accessory fixture (9), and FIBC tote (19).

What is claimed is:

1. A mobile horticulture workstation comprising: a self-supporting outer cart and a self-supporting inner dolly which can be nested longitudinally within said self-supporting outer cart or wherein said self-supporting inner dolly can be unnested longitudinally to operate separately from said self-supporting outer cart.

2. The mobile horticulture workstation of claim 1 wherein said self-supporting outer cart comprises a top, a bottom, an at least two sides opposite one another, an at least two ends opposite one another, a frame with an at least one opening at one of said at least two ends wherein said at least one opening longitudinally receives said self-supporting inner dolly.

3. The mobile horticulture station of claim 1 wherein said self-supporting outer cart further comprises a rolling implement, an at least one or more support racks, an at least one magnetic tool holder, and an at least one mounting sleeve to receive a hanging bar.

4. The mobile horticulture workstation of claim 1 wherein said self-supporting inner dolly comprises, an open top portion, a bottom, an at least two sides opposite one another, an at least two ends opposite one another wherein there is a nesting end and a handle end.

5. The mobile horticulture workstation of claim 1 wherein said self-supporting inner dolly further comprises an attached rolling implement, a container, an accessory fixture, a handle, an at least one hanging bar, and an at least one mounting sleeve for said hanging bar.
